(19) United States
(12) Patent Application Publication
(10) Pub. No.: US 2024/0103440 A1
(43) Pub. Date: Mar. 28, 2024

(54) Method for Holographic Mastering and Replication

(71) Applicant: DigiLens Inc., Sunnyvale, CA (US)

(72) Inventors: Milan Momcilo Popovich, Leicester (GB); Jonathan David Waldern, Los Altos Hills, CA (US); Alastair John Grant, San Jose, CA (US)

(73) Assignee: DigiLens Inc., Sunnyvale, CA (US)

(21) Appl. No.: 18/468,375

(22) Filed: Sep. 15, 2023

Related U.S. Application Data
(63) Continuation of application No. 17/341,155, filed on Jun. 7, 2021, now abandoned.
Application No. 17/341,155 is a continuation of application No. 16/517,461, filed on Jul. 19, 2019, now abandoned.
Application No. 16/517,461 is a continuation of application No. 15/502,596, filed on Feb. 8, 2017, now Pat. No. 10,359,736.
(60) Provisional application No. 61/999,867, filed on Aug. 8, 2014.

(51) Int. Cl. G03H 1/20; G03H 1/02

(52) U.S. Cl. CPC G03H 1/202; G03H 1/0244; G03H 1/0248; G03H 1/265

(57) ABSTRACT

A method for producing holograms with a multiplicity of holographic prescriptions from a single master is provided. A multiplicity of holographic substrates each containing a first hologram is stacked on a second holographic recording medium substrate. The first hologram is designed to diffract light from a first direction into a second direction. When expose to illumination from the first direction zero order and diffracted light from each first hologram interfere in the second holographic recording medium substrate forming a second hologram. The second hologram is then copied into a third holographic recording medium substrate to provide the final copy hologram.

### CROSS-REFERENCE TO RELATED APPLICATIONS

This application is a continuation of U.S. patent application Ser. No. 17/341,155 filed on Jun. 7, 2021, which is a continuation of U.S. patent application Ser. No. 16/517,461 filed on Jul. 19, 2019, which is a continuation of U.S. patent application Ser. No. 15/502,596 filed on Feb. 8, 2017 and issued on Jul. 23, 2019 as U.S. Pat. No. 10,359,736, which is a U.S. National Phase of PCT Application No. PCT/GB2015/000228 filed on Aug. 5, 2015, which claims the benefit of U.S. Provisional Patent Application No. 61/999,867 filed Aug. 8, 2014, the disclosures of which are herein incorporated by reference in their entireties.

### BACKGROUND OF THE INVENTION

The present invention relates to holography and more particularly to an improved method for mastering and replicating holograms.

Replication of holograms is normally carried out by preparing a master hologram of the desired prescription which is then copied into another holographic recording material using a contact process. The master is usually made using a classical two-beam holographic recording system comprising an object beam and a reference beam. However, the master could itself be a copy of another master. In the case of a transmission hologram the copying process is based on interfering the diffracted and zero order beams produced by master to form a grating within the copy hologram material. Subject to processing variations such as shrinkage the holographic pattern or grating formed in the copy should be identical to the one in the master. This procedure may be used in mass production roll-to-roll processes. The principles of holographic replication and industrial processes for the mass production of holograms are well documented in the literature.

The optical design benefits of diffractive optical elements (DOEs) are well known, including unique and efficient form factors and the ability to encode complex optical functions such as optical power and diffusion into thin layers. Bragg gratings (also commonly termed volume phase grating or holograms), which offer the highest diffraction efficiencies, have been widely used in devices such as Head Up Displays. An important class of Bragg grating devices is known as a Switchable Bragg Grating (SBG). An SBG is a diffractive device formed by recording a volume phase grating, or hologram, in a polymer dispersed liquid crystal (PDLC) mixture. Typically, SBG devices are fabricated by first placing a thin film of a mixture of photopolymerizable monomers and liquid crystal material between parallel glass plates or substrates. Techniques for making and filling glass cells are well known in the liquid crystal display industry. One or both glass substrates support electrodes, typically transparent indium tin oxide films, for applying an electric field across the PDLC layer. A volume phase grating is then recorded by illuminating the liquid material with two mutually coherent laser beams, which interfere to form the desired grating structure. During the recording process, the monomers polymerize and the HPDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the PDLC layer. When an electric field is applied to the hologram via transparent electrodes, the natural orientation of the LC droplets is changed causing the refractive index modulation of the fringes to reduce and the hologram diffraction efficiency to drop to very low levels. Note that the diffraction efficiency of the device can be adjusted, by means of the applied voltage, over a continuous range from near 100% efficiency with no voltage applied to essentially zero efficiency with a sufficiently high voltage applied.

SBGs may be used to provide transmission or reflection gratings for free space applications. SBGs may be implemented as waveguide devices in which the HPDLC forms either the waveguide core or an evanescently coupled layer in proximity to the waveguide. In one particular configuration to be referred to here as Substrate Guided Optics (SGO) the parallel glass plates used to form the HPDLC cell provide a total internal reflection (TIR) light guiding structure. Light is “coupled” out of the SBG when the switchable grating diffracts the light at an angle beyond the TIR condition. SGOs are currently of interest in a range of display and sensor applications. Although much of the earlier work on HPDLC has been directed at reflection holograms transmission devices are proving to be much more versatile as optical system building blocks and tend to be much easier to fabricate.

Typically, the HPDLC used in SBGs comprise liquid crystal (LC), monomers, photoinitiator dyes, and coinitiators. The mixture frequently includes a surfactant. The patent and scientific literature contains many examples of material systems and processes that may be used to fabricate SBGs. Two fundamental patents are: U.S. Pat. No. 5,942,157 by Sutherland, and U.S. Pat. No. 5,751,452 by Tanaka et al. both filings describe monomer and liquid crystal material combinations suitable for fabricating SBG devices.

One of the known attributes of transmission SBGs is that the LC molecules tend to align normal to the grating fringe planes. The effect of the LC molecule alignment is that transmission SBGs efficiently diffract P polarized light (ie light with the polarization vector in the plane of incidence) but have nearly zero diffraction efficiency for S polarized light (ie light with the polarization vector normal to the plane of incidence. Transmission SBGs may not be used at near-grazing incidence as the diffraction efficiency of any grating for P polarization falls to zero when the included angle between the incident and reflected light is small. A glass light guide in air will propagate light by total internal reflection if the internal incidence angle is greater than about 42 degrees. Thus waveguide transmission SBGs may be used if the internal incidence angles are in the range of 42 to about 70 degrees, in which case the light extracted from the light guide by the gratings will be predominantly p-polarized.

Normally SBGs diffract when no voltage is applied and are switching into their optically passive state when a voltage is application other times. However SBGs can be designed to operate in reverse mode such that they diffract when a voltage is applied and remain optically passive at all other times. Methods for fabricating reverse mode SBGs are disclosed in a U.S. Provisional Patent Application No. 61/573,066. with filing date 24 Aug. 2011 by the present inventors entitled IMPROVEMENTS TO HOLOGRAPHIC POLYMER DISPERSED LIQUID CRYSTAL MATERIALS AND which is incorporated by reference herein in its entirety. The same reference also discloses how SBGs may be fabricated using flexible plastic substrates to provide the benefits of improved ruggedness, reduce weight and safety in near eye applications.

The present invention is motivated by the requirement to record SBGs of differing optical prescriptions for use in image transmitting waveguides currently being designed for Head Up Displays (HUDs) and Head Mounted Displays (HMDs). The holograms may configured as stacks U.S. Pat. No. 8,233,204 entitled OPTICAL DISPLAYS U.S. patent application Ser. No. 13/844,456 entitled WIDE FIELD OF VIEW COLOR DISPLAY; or tessellated in single layers as disclosed in U.S. patent application Ser. No. 13/869,866 entitled APERTURE SAMPLING FOR DUAL AXIS SAMPLING. In such applications the holograms are used to tile a field of view (FOV) space and/or increase the size of the exit pupil. For large FOV full colour displays the number of holographic prescriptions can be high as the FOV of a holographic element is limited by diffraction efficiency angular bandwidth. Since the cost of fabricating masters using conventional holographic interferometry or ruling processes is currently very high this can make the manufacture of large FOV displays very expensive. Exemplary holographic masters and replicas thereof) are provided by companies such as Holographix Inc. (MA). Typically, masters are surface relief components fabricated using holographic, binary grating etching or mechanical ruling processes. Desirably, a mastering and replication process for large FOV holographic waveguides should provide a range of optical prescriptions spanning the required FOV space using a minimal number of master components. Ideally this should be accomplished with just one master. Applications such as HMDs and HUDs typically demand tight control of the diffraction efficiency and geometrical optical characteristics of the replicated holograms. In particular there is a need for precise control of the intensities of the diffracted and zero order beams. Currently available holographic mastering process suffer from the problem that the relative intensities of the diffracted and zero orders cannot be controlled to better than ±5%. As disclosed in a co-pending patent application PCT/GB2013/000273 the inventors have discovered that a perfect copy can be made if the master hologram is “over-modulated” by a small amount. Over-modulation in this context means that the refractive index modulation of the hologram is a little above that required to achieve the desired beam ratio. The next step is to separately attenuate the master beams to bring them to the desired ratio. Typically we require 50/50 or 1:1. However, the inventors have found that making a perfect master with the appropriate level of over-modulation, which is typically 5-10%, is very difficult in practice. To the best of the inventors' knowledge the required levels of index modulation control have not been achieved using conventional holographic recording processes using currently available holographic recording materials such as photopolymers and Photo Thermo Refractive (PTR) materials. Desirably a holographic mastering process should include methods for controlling the hologram modulation.

There is requirement for an efficient and cost-effective method for replicating holograms with a multiplicity of holographic prescriptions from a single master.

### SUMMARY OF THE INVENTION

There is provided a efficient and cost-effective method for replicating holograms with a multiplicity of holographic prescriptions from a single master.

The objects of the invention are achieved in a first embodiment in which there is provided a method for mastering and replicating holograms, the method comprising:
a) providing N substrates each containing a first hologram for diffracting incident light from a first direction into diffracted light in a second direction; providing a second holographic recording medium; and providing a third holographic recording medium;
b) stacking in sequence the first holograms 1-N onto the second holographic recording medium;
c) illuminating external surface of the first hologram N with light of a first polarization in a first direction;
d) the first holograms 1-N diffracting the light into zero order light in the first direction and diffracted light in the second direction;
e) the first direction light and the second direction light interfering in the second holographic recording medium to form a second hologram;
f) placing the second hologram in contact with the third holographic recording medium;
g) illuminating external surface of the second hologram with light in the first direction;
h) the second hologram diffracting the light into zero order light in the first direction and diffracted light in the second direction;
i) the diffracted and first order light interfering in the third holographic recording medium to form a third hologram.

In one embodiment of the invention steps c) to i) are repeated for a multiplicity of values of the first and second directions. The first and second directions are limited by the diffraction efficiency angular bandwidth of said first hologram.

In one embodiment of the invention the first holograms 1,N are provided by the steps of: configuring a laser holographic recording apparatus to form a first recording beam in the first direction and a second recording beams in the second direction; providing N substrates each containing a first holographic medium; and the first and second beams interfering within each the first holographic medium substrate to form the first hologram in each the substrate.

In one embodiment the first holograms 1,N are surface relief structures. In one embodiment the first holograms 1,N are binary structures.

In one embodiment step a) further comprises providing a half wave plate (HWP) and step c) further comprises disposing the HWP between the holographic recording medium substrate and the first hologram stack. In a further embodiment step a) further comprises providing a linear polarizer and in step c) further comprises disposing the linear polarizer between the HWP and the first hologram stack.

In one embodiment the first holographic recording medium is a HPDLC for recording a SBG, the second holographic recording medium is a holographic photopolymer and the third holographic recording medium is a holographic photopolymer. In one embodiment of the invention the third hologram is a copy of the second hologram and the second hologram is a copy of the first hologram.

In one embodiment of the invention the third holographic recording medium comprises HPDLC material components for forming one of a forward mode SBG or a reverse mode SBG.

In one embodiment of the invention the zero order light and diffracted light in at least one step d) and step i) have power substantially in the ratio of 1:1.

In one embodiment of the invention the third holographic recording medium has a substrate fabricated from optical plastic.

In one embodiment of the invention the second hologram and the third holographic recording medium are separated by an air gap. In one embodiment the second hologram and the third holographic recording medium are in contact.

In one embodiment of the invention the third holographic recording medium forms part of a mechanically translatable continuous lamina.

In one embodiment of the invention there is further provided a voltage generator for applied a voltage across at least one of the second hologram and the third holographic recording medium. The applied voltage varies the refractive index modulation of at least one of the second hologram and the third hologram during steps g) to i).

In one embodiment of the invention the second holographic recording medium is one of a photo thermal refractive or holographic photopolymer, a forward mode HPDLC mixture or a reverse mode HPDLC mixture. In one embodiment of the invention the third holographic recording medium is one of a photo thermal refractive or photopolymer, a forward mode HPDLC mixture or a reverse mode HPDLC mixture.

In one embodiment of the invention the diffracting thickness of the first hologram is less than or equal to 1 micron. In one embodiment of the invention the diffracting thickness of the first hologram is less than or equal to 2 micron.

In one embodiment of the invention there is provided a method of mastering and replicating holograms, the method comprising:
a) providing a laser apparatus for forming a first recording beam in a first direction and a second recording beams in a second direction; N substrates each containing a first HPDLC mixture; a holographic photopolymer; a copy holographic substrate containing a second HPDLC mixture; a HWP; and a linear polarizer;
b) the first and second beams interfering within each the first HPDLC mixture to form a first hologram in each substrate;
c) stacking in sequence the linear polarizer, HWP and first holograms 1-N onto the second holographic photopolymer;
d) illuminating external surface of the hologram N with light of a first polarization in the first direction;
e) the first holograms 1-N diffracting the light into zero order light in the first direction and diffracted light in the second direction;
f) the HWF rotating the incident light polarization through ninety degrees into a second polarization;
g) the linear polarizer removing residual first polarization light;
h) the first direction light and the second direction light interfering in the holographic photopolymer to form a second hologram;
i) placing the second hologram in contact with the copy holographic substrate;
j) illuminating external surface of the second hologram with light of the second polarization in the first direction;
k) the second hologram diffracting the light into zero order light in the first direction and diffracted light in the second direction;
l) the diffracted and first order light interfering in the copy holographic substrate to form a third hologram.

In one embodiment of the invention steps d) to l) are repeated for a multiplicity of values of the first and second directions, wherein the first and second directions are limited by the diffraction efficiency angular bandwidth of the first hologram.

In one embodiment of the invention the first polarization is P-polarization and the second polarization is S-polarization.

A more complete understanding of the invention can be obtained by considering the following detailed description in conjunction with the accompanying drawings, wherein like index numerals indicate like parts. For purposes of clarity, details relating to technical material that is known in the technical fields related to the invention have not been described in detail.

### BRIEF DESCRIPTION OF THE DRAWINGS

FIG. 1 is a flowchart illustrating a process for mastering and replicating holograms in one embodiment of the invention.

FIG. 2A is a cross section view of a stack of first holograms in one embodiment.

FIG. 2B is a schematic cross section view of a stack comprising first holograms, a linear polarizer, a half wave plate and second holographic recording medium in one embodiment.

FIG. 2C is a schematic cross section view of a second hologram in contact with a third holographic recording medium in one embodiment of the invention.

FIG. 3A is a schematic cross section view of a stack of first holograms in one embodiment of the invention.

FIG. 3B is a schematic cross section view of a stack comprising a stack of first holograms, a linear polarizer, a half wave plate and second holographic recording medium in one embodiment of the invention.

FIG. 3C is a schematic cross section view of a second hologram in contact with a third holographic recording medium in one embodiment of the invention.

FIG. 4A is a schematic cross section view of a first hologram in one embodiment of the invention.

FIG. 4B is a schematic cross section view of a stack of first holograms showing ray paths in one embodiment of the invention.

FIG. 4C is a schematic cross section view of a stack comprising a stack of first holograms, a linear polarizer, a half wave plate and second holographic recording medium showing ray paths for a first illumination direction in one embodiment of the invention.

FIG. 4D is a schematic cross section view of a stack comprising a stack of first holograms, a linear polarizer, a half wave plate and second holographic recording medium showing ray paths for a second illumination direction in one embodiment of the invention.

FIG. 4E is a schematic cross section view of a second hologram in contact with a third holographic recording medium showing ray paths in one embodiment of the invention.

FIG. 5 is a schematic illustration illustrating the use of an electric field to control the refractive index modulations of the first holograms during the recording of the second hologram in one embodiment of the invention

FIG. 6 is a schematic illustration illustrating the use of an electric field to control the refractive index modulations of the second hologram during the recording of the third hologram in one embodiment of the invention

FIG. 7 is a schematic illustration of an optical arrangement for recording on of the first holograms in one embodiment of the invention.

FIG. 8 is a flowchart illustrating a process for mastering and replicating holograms in one embodiment of the invention.

FIG. 9 is a flowchart illustrating a process for mastering and replicating holograms in one embodiment of the invention.

FIG. 10 is a flowchart illustrating a process for mastering and replicating holograms in one embodiment of the invention.

FIG. 11 is a flowchart illustrating a process for mastering and replicating holograms in one embodiment of the invention.

FIG. 12 is a flowchart illustrating a process for mastering and replicating holograms in one embodiment of the invention.

### DETAILED DESCRIPTION OF THE INVENTION

The invention will now be further described by way of example only with reference to the accompanying drawings. It will apparent to those skilled in the art that the present invention may be practiced with some or all of the present invention as disclosed in the following description. For the purposes of explaining the invention well-known features of optical technology known to those skilled in the art of optical design and visual displays have been omitted or simplified in order not to obscure the basic principles of the invention. Unless otherwise stated the term “on-axis” in relation to a ray or a beam direction refers to propagation parallel to an axis normal to the surfaces of the optical components described in relation to the invention. In the following description the terms light, ray, beam and direction may be used interchangeably and in association with each other to indicate the direction of propagation of light energy along rectilinear trajectories. Parts of the following description will be presented using terminology commonly employed by those skilled in the art of optical design. The term “grating” may be used to describe a hologram. It should also be noted that in the following description of the invention repeated usage of the phrase “in one embodiment” does not necessarily refer to the same embodiment.

The present invention provides a method for producing holograms with a multiplicity of holographic prescriptions from a single master. The master which will be described as a first hologram is characterised by a wide angular bandwidth. Desirably, the first hologram also has large index modulation. This allows a wide range of input and diffracted beam angles to be generated by the first hologram. For each set of input and diffracted beam angle an intermediate master (second) hologram is recorded. The resulting set of intermediate master (second) holograms may then be used to contact copy the hologram into the desired copy medium to provide a copy (third) hologram. A wide bandwidth hologram will have a small thickness which results have relatively low diffraction efficiency. In the proposed method the problem of low diffraction efficiency is overcome by stacking a multiplicity of holographic substrates each containing the first hologram. This stack is then overlaid on stacked on a second holographic recording medium substrate. The first hologram is designed to diffract light from a first direction into a second direction. When exposed to illumination from the first direction zero order and diffracted light from each (first) hologram in the stack interfere in the second holographic recording medium substrate forming a second hologram. The second hologram is then copied into a third holographic recording medium substrate to provide the final copy hologram. The invention may be used to master and replicate any type of hologram in any type of holographic recording material. The invention may be used to master and replicated passive or switchable holograms. The holograms may be single elements or switchable arrays as described in PCT/GB2013/000273. Voltages may be applied across the second hologram to control the index modulation and hence fine tune beam ratios during the final contact copying stage. Voltages may also be applied across the first holograms during the recording of the second hologram.

In one embodiment of the invention there is provided a method for mastering and replicating holograms, the method comprising:
a) providing N substrates each containing a first hologram for diffracting incident light from a first direction into diffracted light in a second direction; providing a second holographic recording medium; and providing a third holographic recording medium;
b) stacking in sequence the first holograms 1-N onto the second holographic recording medium;
c) illuminating external surface of the first hologram N with light of a first polarization in a first direction;
d) the first holograms 1-N diffracting the light into zero order light in the first direction and diffracted light in the second direction;
e) the first direction light and the second direction light interfering in the second holographic recording medium to form a second hologram;
f) placing the second hologram in contact with the third holographic recording medium;
g) illuminating external surface of the second hologram with light in the first direction;
h) the second hologram diffracting the light into zero order light in the first direction and diffracted light in the second direction;
i) the diffracted and first order light interfering in the third holographic recording medium to form a third hologram.

In one embodiment of the invention steps c) to i) are repeated for a multiplicity of values of the first and second directions. The first and second directions are limited by the diffraction efficiency angular bandwidth of said first hologram.

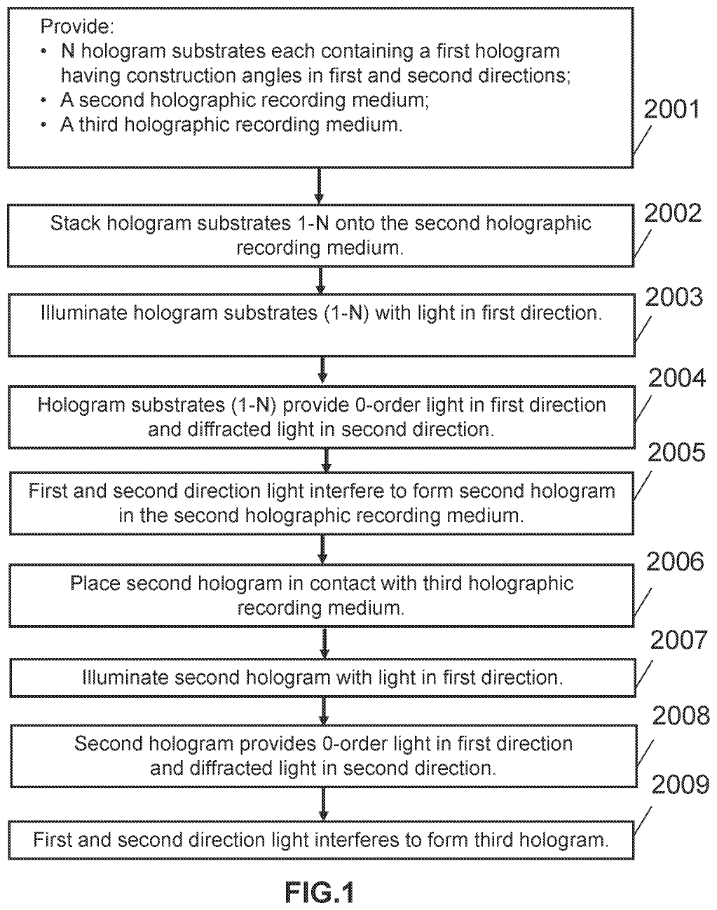

A method of replicating a hologram in one embodiment of the invention in accordance with the basic principles of the invention is shown in the flow diagram in FIG. 1. Referring to the flow diagram, we see that the method comprises the following steps:
At step 2001 provide N hologram substrates each containing a first hologram having construction angles in first and second directions; a second holographic recording medium; and a third holographic recording medium.
At step 2002 stack hologram substrates 1-N onto the second holographic recording medium
At step 2003 illuminate hologram substrates (1-N) with light in the first direction
At step 2004 hologram substrates (1-N) provide 0-order light in the first direction and diffracted light in the second direction.
At step 2005 the first and second direction light interferes to form a second hologram in the second holographic recording medium.
At step 2006 place the second hologram in contact with the third holographic recording medium.
At step 2007 illuminate the second hologram with light in the first direction.
At step 2008 the second hologram provides 0-order light in the first direction and diffracted light in the second direction.
At step 2009 the first and second direction light interferes to form the third hologram.

Note that in terms of defining the holographic prescription a hologram having construction angles in the first and second directions is equivalent to the same hologram diffracting incident light from a first direction into diffracted light in a second direction.

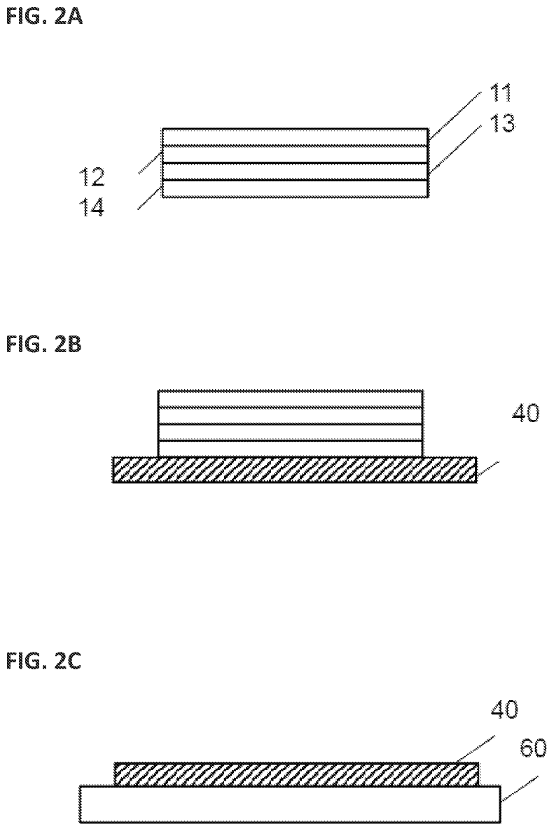

FIG. 2A shows the stack of first holograms labelled by 11-12. FIG. 2B shows the stack of first holograms overlaying of the second holographic recording medium 40. FIG. 2C shows the second hologram overlaying the third holographic recording medium.

In one embodiment of the invention the first holograms 1,N are provided by the steps of firstly, configuring a laser holographic recording apparatus to form a first recording beam in the first direction and a second recording beams in the second direction; secondly, providing N substrates each containing a first holographic medium; and, thirdly, the first and second beams interfering within each the first holographic medium substrate to form the first hologram in each substrate. The present invention does not assume that any particular holographic recording process or HPDLC material is used to fabricate the first holograms. Any of the processes and material systems currently used to fabricate SBGs may be used such as for example the ones disclosed in U.S. Pat. No. 5,942,157 by Sutherland, and U.S. Pat. No. 5,751,452 by Tanaka. The master may be recorded using currently available industrial processes such as the ones provided by companies such as Holographix LLC (MA). Ideally, the master would be recorded using remote computer controlled equipment, which by removing human presence eliminates vibrations and thermal variations that may adversely affect the quality of the recording process. Ideally, the master recording laboratory should be protected from vibrations from external disturbances. Desirably, the master hologram recording equipment will provide active fringe stabilization.

In the preferred embodiments the first hologram and third (copy) holograms are SBGs. In one embodiment the SBGs are reverse mode such the hologram diffracts when a voltage is applied and remains optically passive at all other times. A reverse mode SBG will provide lower power consumption. A reverse mode HPDLC and methods for fabricating reverse mode SBG devices is disclosed in U.S. Provisional Patent Application No. 61/573,066. with filing date 24 Aug. 2011 by the present inventors entitled IMPROVEMENTS TO HOLOGRAPHIC POLYMER DISPERSED LIQUID CRYSTAL MATERIALS AND which is incorporated by reference herein in its entirety. Ultimately, the inventors aim to make replica SBGs with plastic substrates and flexible transparent conductive coatings (to replace ITO). Plastic SBG technology suitable for the present invention is also disclosed in U.S. Provisional Patent Application No. 61/573,066. A reverse mode SBG is more ideally suited to mastering as it avoids the degradation of SBG material that occurs with UV recording. Advantageously, the SBGs will used thin flexible glass substrates such as the ones developed by Corning and Schott driven by the touch panel and smart phone industries.

In one embodiment of the invention the first holograms 1,N are surface relief structures such as binary structures. Such holograms would typically require index matching layers between the hologram layers

In one embodiment of the invention step a) further comprises providing a half wave plate (HWP) and step c) further comprises disposing the HWP between the holographic recording medium substrate and the first hologram stack. In a further embodiment step a) further comprises providing a linear polarizer and in step c) further comprises disposing the linear polarizer between the HWP and the first hologram stack.

In one embodiment of the invention the first holographic recording medium is a HPDLC for recording a SBG, the second holographic recording medium is a holographic photopolymer and the third holographic recording medium is a holographic photopolymer. In one embodiment of the invention the third hologram is copy of the second hologram and the second hologram is a copy of the first hologram. In one embodiment of the invention the third holographic recording medium comprises HPDLC material components for forming one of a forward mode SBG or a reverse mode SBG. In one embodiment of the invention the zero order light and diffracted light in at least one step d) and step i) have power substantially in the ratio of 1:1. In one embodiment of the invention the third holographic recording medium has a substrate fabricated from optical plastic. In one embodiment of the invention the second hologram and the third holographic recording medium are separated by an air gap. In one embodiment of the invention the second hologram and the third holographic recording medium are in contact. In one embodiment of the invention the third holographic recording medium forms part of a mechanically translatable continuous lamina.

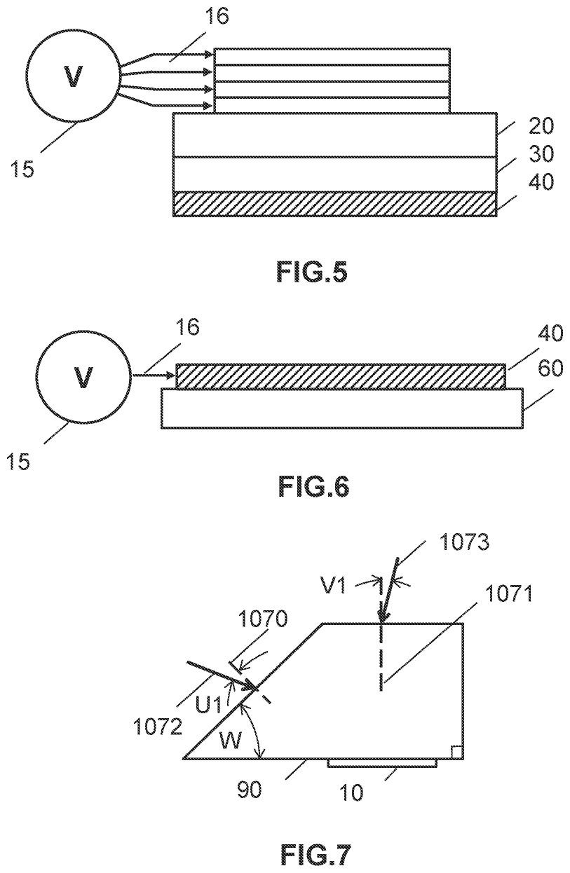

In one embodiment of the invention there is further provided a voltage generator for applied a voltage across at least one of the second hologram and the third holographic recording medium according to the principles disclosed in PCT/GB2013/000273 entitled ELECTRICALLY CONTROLLABLE MASTER HOLOGRAM FOR CONTACT COPYING. The voltage varies the refractive index modulation of at least one of the second hologram and the third during steps g) to i). FIG. 5 illustrates the application of a voltage across the first holograms using the voltage generator 15 via the connectors 16. FIG. 6 illustrates the application of a voltage across the second hologram using the voltage generator 15 via the connectors 17.

In one embodiment of the invention the second holographic recording medium is one of a photo thermal refractive or holographic photopolymer, a forward mode HPDLC mixture or a reverse mode HPDLC mixture. In one embodiment of the invention the third holographic recording medium is one of a photo thermal refractive or photopolymer, a forward mode HPDLC mixture or a reverse mode HPDLC mixture. In one embodiment of the invention the diffracting thickness of the first hologram is less than or equal to 1 micron. In one embodiment of the invention the diffracting thickness of the first hologram is less than or equal to 2 micron.

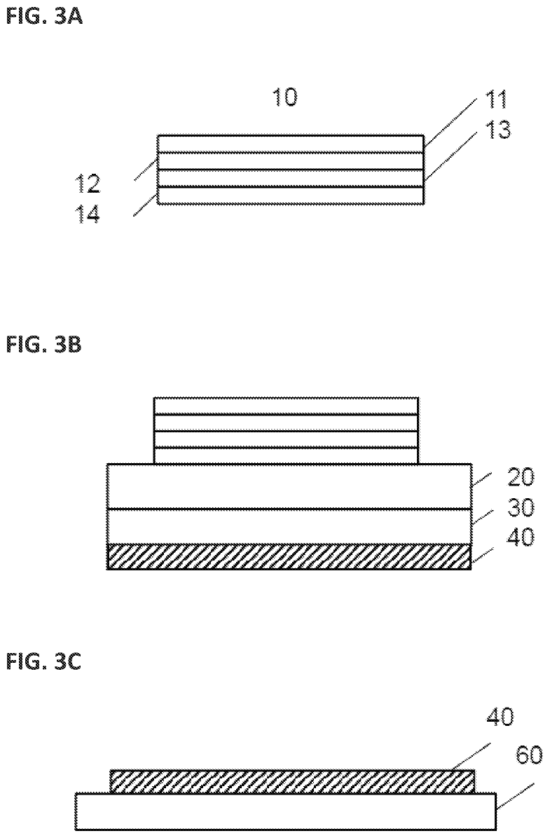

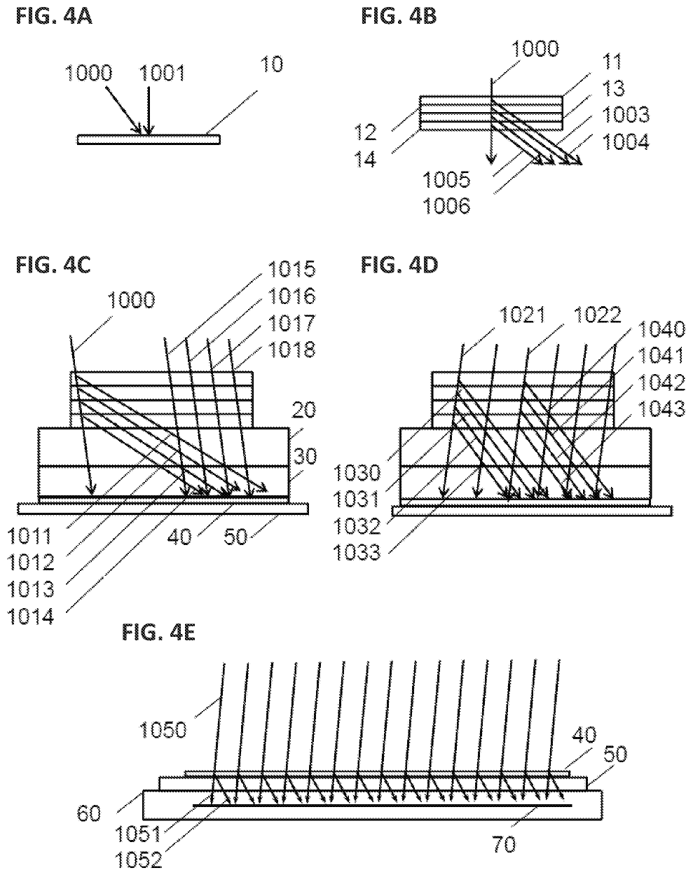

In one embodiment of the invention illustrated in FIGS. 2A-2C, 3A-3C and 4A-4E there is provided a method of mastering and replicating holograms, the method comprising:
a) providing a laser apparatus for forming a first recording beam in a first direction 1000 and a second recording beam in a second direction 1001; a stack 10 of substrates 11-14 each containing a first HPDLC mixture; a holography photopolymer 40 on a substrate 50; a copy holographic substrate 60 containing a second HPDLC mixture 70; a HWP 20; and a linear polarizer 30 in FIGS. 3A-3C and 4A-4E;
b) the first and second beams interfering within each the first HPDLC mixture to form a first hologram in each substrate;
c) stacking in sequence the linear polarizer, HWP and first holograms (1-N) onto the second holographic photopolymer;
d) illuminating external surface of the holograms (1-N) with light of a first polarization in the first direction, as indicated by rays 1015-1018 in FIG. 4C;
e) the first holograms (1-N) diffracting the light into zero order light in the first direction 1000 and diffracted rays 1011-1014 in FIG. 4C in the second direction;
f) the HWP rotating the incident light polarization through ninety degrees into a second polarization;
g) the linear polarizer removing residual first polarization light;
h) the first direction light and the second direction light interfering in the holographic photopolymer to form a second hologram;
i) placing the second hologram in contact with the copy holographic substrate;
j) illuminating external surface of the second hologram with light of the second polarization in the first direction 1050;
k) the second hologram diffracting the light into zero order light 1051 in the first direction and diffracted light in the second direction 1052;
l) the diffracted and first order interfering in the copy holographic substrate to form a third hologram.

In one embodiment of the invention steps d) to l) are repeated for a multiplicity of values of the first and second directions, wherein the first and second directions are limited by the diffraction efficiency angular bandwidth of the first hologram. For example FIG. 4D shows the step of FIG. 4C in which the first direction is at an opposing angle to the first direction of FIG. 4C as indicated by the rays 1021,1022. This results in a different diffraction direction as indicated by the rays 1030-1033 and 1040-1043. The first direction of FIG. 4D is also used in FIG. 4E.

In the embodiment of FIGS. 2-3 the first polarization is P and the second polarization is S. The first hologram is ideally a thin wide angular bandwidth SBG. Thinner grating will provide a broader angular bandwidth. Typically the grating thickness may range from 0.5-1.0 microns depending on the angular bandwidth required. The SBGs are recorded using S-polarized light. The second hologram is recorded into a high quality holographic photopolymer material such as the ones supplied by Bayer Inc. In this case the second hologram is illuminated with P-polarized light as SBGs will only diffract P. To achieve the best contrast in the second hologram the exposure must use S-polarized light. This is done by means of the half wave plate (for rotating P to S) and linear polarizer (for removing residual P-polarised light). Fine tuning of the beam ration is provided by optimizing the angle of the HWP relative to the linear polarizer. The aim is to have the ratio of diffracted to zero order light in the second hologram as close to 1:1 as possible to provide the optimal beam ratio for the recording of the third hologram. At this point it will be desirable to increase the source brightness to compensate for light losses through the polarizing components. As discussed above beam intensity may be fined tune by applying voltages to the first holograms. The third hologram is created using a contact copy process in which the second hologram is illuminated by S-polarized light

FIG. 7 is a schematic illustration of an optical arrangement using a dove prism for recording on of the first holograms in one embodiment of the invention. The dove prism 90 with acute angle W (typically 45 degree) has its base in contact with the first hologram substrate 10. Construction beams in the directions 1072,1073 at angles U1,V1 to the surface normals 1070,1071 interfere in the substrate 10 to form the first hologram.

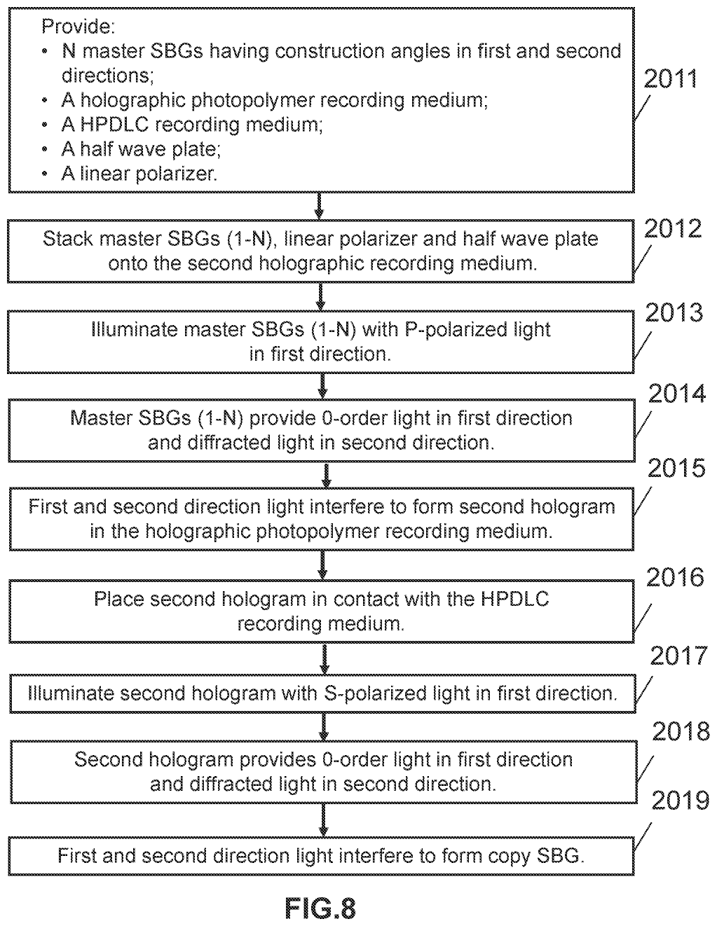

A method of replicating a hologram according to a preferred embodiment of the invention in accordance with the basic principles of the invention is shown in the flow diagram in FIG. 8. Referring to the flow diagram, we see that the method comprises the following steps:
At step 2011 provide: N master SBGs having construction angles in the first and second directions; a holographic photopolymer recording medium; a HPDLC recording medium; a half wave plate; and a linear polarizer.
At step 2012 stack the master SBGs (1-N), linear polarizer and half wave plate onto the second holographic recording medium.
At step 2013 illuminate the master SBGs (1-N) with P-polarized light in the first direction.
At step 2014 master SBGs (1-N) provide 0-order light in the first direction and diffracted light in the second direction.
At step 2015 the first and second direction light interferes to form the second hologram in the holographic photopolymer recording medium.
At step 2016 place the second hologram in contact with the HPDLC recording medium.
At step 2017 illuminate the second hologram with S-polarized light in the first direction.
At step 2018 the second hologram provides 0-order light in the first direction and diffracted light in the second direction.
At step 2019 the first and second direction light interferes to form a copy SB G.

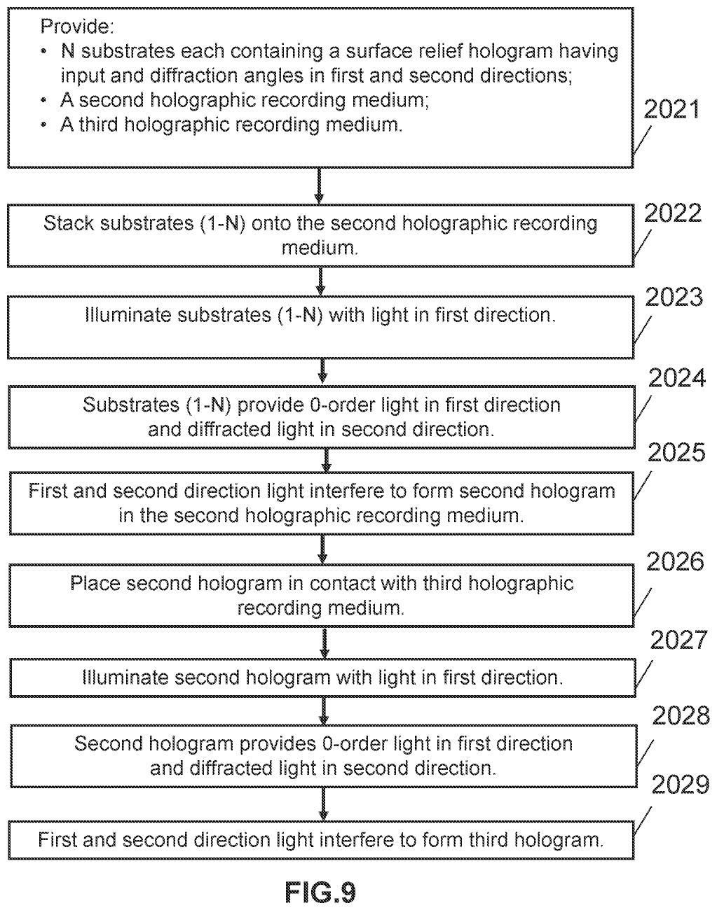

In one embodiment of the invention the first hologram is a surface relief hologram such as binary grating. A method of replicating a hologram in one embodiment of the invention in accordance with the basic principles of the invention is shown in the flow diagram in FIG. 9. Referring to the flow diagram, we see that the method comprises the following steps:
At step 2021 provide: N substrates each containing a surface relief hologram having input and diffraction angles in first and second directions; a second holographic recording medium; and a third holographic recording medium.
At step 2022 stack substrates (1-N) onto the second holographic recording medium.
At step 2023 illuminate substrates (1-N) with light in the first direction.
At step 2024 substrates (1-N) provide 0-order light in the first direction and diffracted light in the second direction.
At step 2025 the first and second direction light interferes to form the second hologram in the second holographic recording medium.
At step 2026 place the second hologram in contact with the third holographic recording medium.
At step 2027 illuminate the second hologram with light in the first direction.
At step 2028 the second hologram provides 0-order light in the first direction and diffracted light in second direction.
At step 2029 the first and second direction light interferes to form a copy SB G.

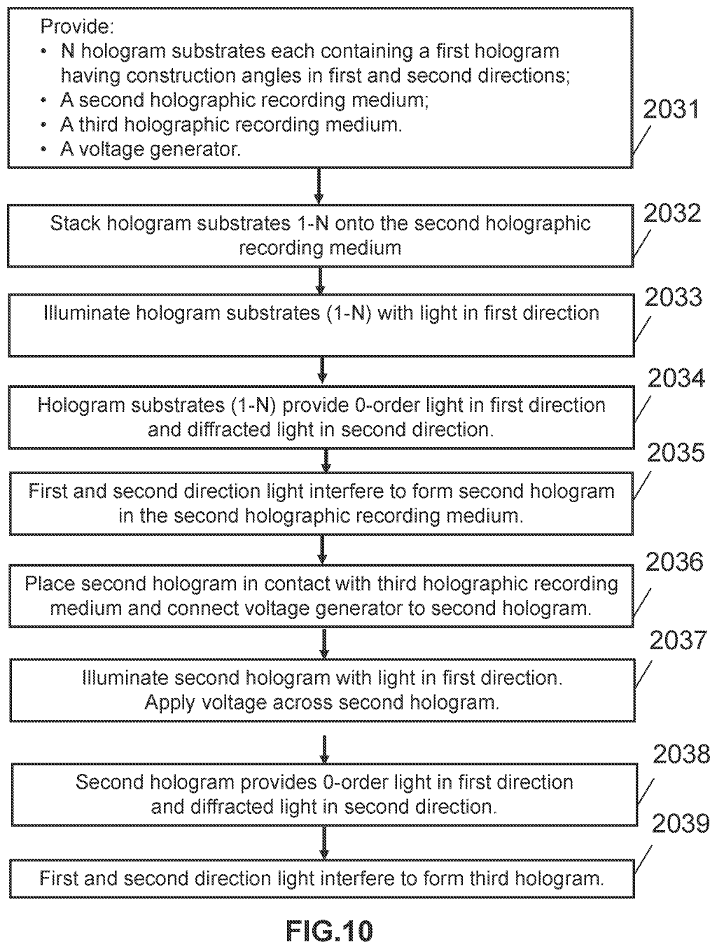

As illustrated in FIGS. 5-6 in one embodiment of the invention there is further provided a voltage generator for applied a voltage across at least one of the second hologram and the third holographic recording medium. A method of replicating a hologram in one embodiment of the invention in accordance with the basic principles of the invention is shown in the flow diagram in FIG. 10. Referring to the flow diagram, we see that the method comprises the following steps:
At step 2031 provide: N hologram substrates each containing a first hologram having construction angles in first and second directions; a second holographic recording medium; a third holographic recording medium; and a voltage generator.
At step 2032 stack the hologram substrates (1-N) onto the second holographic recording medium.
At step 2033 illuminate the hologram substrates (1-N) with light in the first direction.
At step 2034 the hologram substrates (1-N) provide 0-order light in the first direction and diffracted light in the second direction.
At step 2035 the first and second direction light interferes to form the second hologram in the second holographic recording medium.
At step 2036 place the second hologram in contact with the third holographic recording medium and connect the voltage generator to the second hologram.
At step 2037 illuminate the second hologram with light in the first direction. Apply a voltage across the second hologram.
At step 2038 the second hologram provides 0-order light in the first direction and diffracted light in the second direction.
At step 2039 the first and second direction light interferes to form a third hologram.

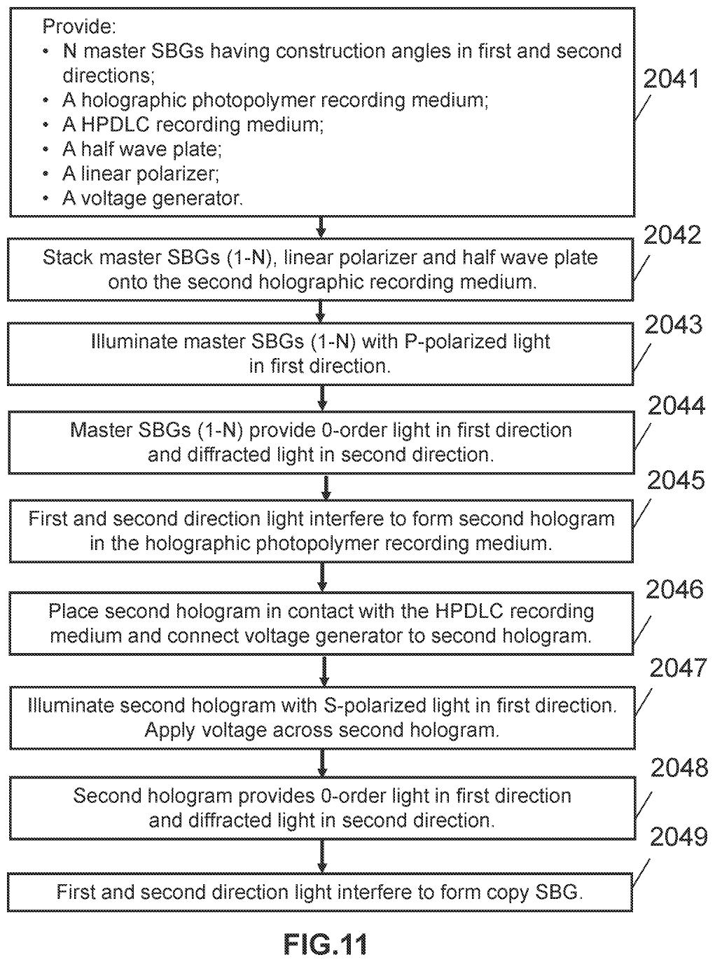

A further method of replicating a hologram in one embodiment of the invention in accordance with the basic principles of the invention is shown in the flow diagram in FIG. 11. Referring to the flow diagram, we see that the method (based on the preferred embodiment discussed above and illustrated in FIG. 8) comprises the following steps:
At step 2041 provide: N master SBGs having construction angles in first and second directions; a holographic photopolymer recording medium; a HPDLC recording medium; a half wave plate; a linear polarizer; and a voltage generator.
At step 2042 stack the master SBGs (1-N), linear polarizer and half wave plate onto the second holographic recording medium.
At step 2043 illuminate the master SBGs (1-N) with P-polarized light in the first direction.
At step 2044 the master SBGs (1-N) provide 0-order light in the first direction and diffracted light in the second direction.
At step 2045 the first and second direction light interferes to form the second hologram in the holographic photopolymer recording medium.
At step 2046 place the second hologram in contact with the HPDLC recording medium and connect the voltage generator to the second hologram.
At step 2047 illuminate the second hologram with S-polarized light in the first direction. Apply a voltage across the second hologram.
At step 2048 the second hologram provides 0-order light in the first direction and diffracted light in the second direction.
At step 2049 the first and second direction light interferes to form a copy SB G.

In one embodiment of the invention steps are repeated for a predefined number of holographic prescriptions, that is, for a multiplicity of vectors defining the first and second directions. One first hologram (master) is used to produce all replicas at each prescription. The first holograms (1-N) are illumination by each first direction vector of a predefined set in turn. The first and second directions are limited by the diffraction efficiency angular bandwidth of said first hologram.

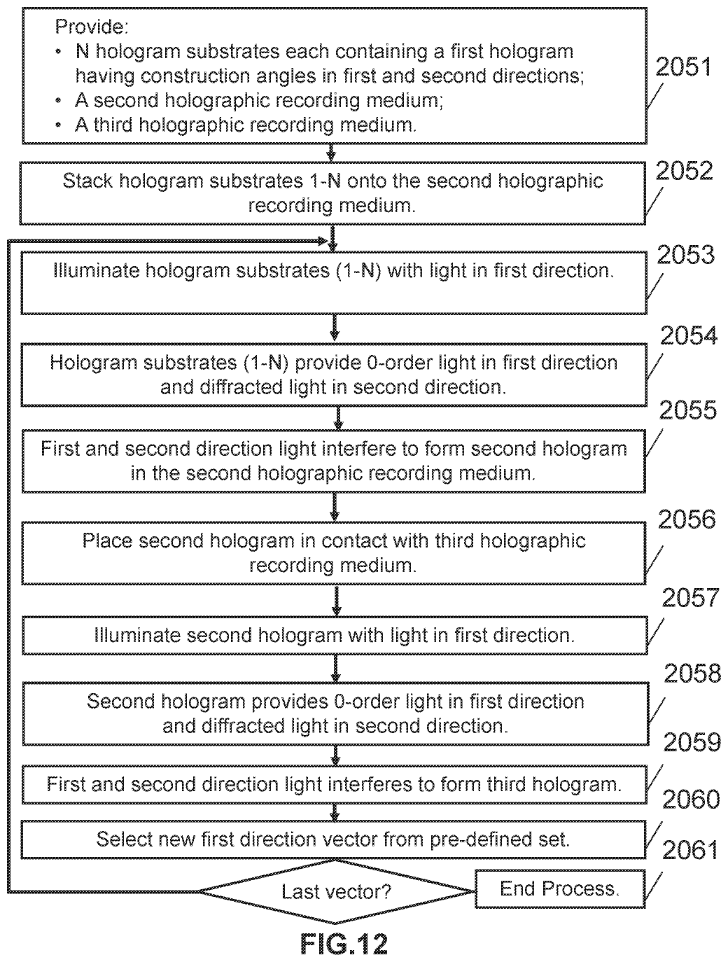

A method of replicating a hologram in one embodiment of the invention (based on the embodiment of FIG. 1) in accordance with the basic principles of the invention is shown in the flow diagram in FIG. 12. Referring to the flow diagram, we see that the method comprises the following steps:
At step 2051 provide N hologram substrates each containing a first hologram having construction angles in first and second directions; a second holographic recording medium; and a third holographic recording medium.
At step 2052 stack hologram substrates 1-N onto the second holographic recording medium
At step 2053 illuminate hologram substrates (1-N) with light in the first direction
At step 2054 hologram substrates (1-N) provide 0-order light in the first direction and diffracted light in the second direction.
At step 2055 the first and second direction light interferes to form a second hologram in the second holographic recording medium.
At step 2056 place the second hologram in contact with the third holographic recording medium.
At step 2057 illuminate the second hologram with light in the first direction.
At step 2058 the second hologram provides 0-order light in the first direction and diffracted light in the second direction.
At step 2059 the first and second direction light interferes to form the third hologram.
At step 2060 a new first direction vector is selected from a pre-defined set.
At step 2061 the process is repeated from step 2053 onwards until the last vector in the pre-defined set has been selected.

It should be understood by those skilled in the art that while the present invention has been described with reference to exemplary embodiments, it is to be understood that the invention is not limited to the disclosed exemplary embodiments. Various modifications, combinations, sub-combinations and alterations may occur depending on design requirements and other factors insofar as they are within the scope of the appended claims or the equivalents thereof.

What is claimed is:

1. A method for mastering and replicating holograms, the method comprising:
a) providing N substrates each containing a first hologram for diffracting incident light from a first direction into diffracted light in a second direction; providing a second holographic recording medium; and providing a third holographic recording medium;
b) stacking in sequence the first holograms 1-N onto said second holographic recording medium;
c) illuminating external surface of said first hologram N with light of a first polarization in a first direction;
d) said first holograms 1-N diffracting said light into zero order light in said first direction and diffracted light in said second direction;
e) said first direction light and said second direction light interfering in said second holographic recording medium to form a second hologram;
f) placing said second hologram in contact with said third holographic recording medium;
g) illuminating external surface of said second hologram with light in said first direction;
h) said second hologram diffracting said light into zero order light in said first direction and diffracted light in said second direction;
i) said diffracted and first order light interfering in said third holographic recording medium to form a third hologram.

2. The method of claim 1 wherein said steps c) to i) are repeated for a multiplicity of values of said first and second directions, wherein said first and second directions are limited by the diffraction efficiency angular bandwidth of said first hologram.

3. The method of claim 1 wherein the first holograms 1,N are provided by the steps of: configuring a laser holographic recording apparatus to form a first recording beam in said first direction and a second recording beams in said second direction; providing N substrates each containing a first holographic medium; and said first and second beams interfering within each said first holographic medium substrate to form said first hologram in each said substrate.

4. The method of claim 1 wherein said first holograms 1,N are surface relief diffractive structures.

5. The method of claim 1 further comprising in step a) providing a HWP and in step c) disposing said HWP between said holographic recording medium substrate and said first hologram stack.

6. The method of claim 5 further comprising in step a) providing a linear polarizer and in step c) disposing said linear polarizer between said HWP and said first hologram stack.

7. The method of claim 1 wherein said first holographic recording medium is a HPDLC for recording a SBG, said second holographic recording medium is a holographic photopolymer and said third, holographic recording medium is a holographic photopolymer.

8. The method of claim 1 wherein said third hologram is copy of said second hologram and said second hologram is a copy of said first hologram.

9. The method of claim 1 wherein said third holographic recording medium comprises HPDLC material components for forming a forward mode SBG or a reverse mode SBG.

10. The method of claim 1 wherein said zero order light and diffracted light in at least one step d) and step i) have power substantially in the ratio of 1:1.

11. The method of claim 1 wherein said second hologram and said third holographic recording medium are separated by an air gap.

12. The method of claim 1 wherein at least one index matching optical layer is provided.

13. The method of claim 1 wherein said third holographic recording medium forms part of a mechanically translatable continuous lamina.

14. The method of claim 1 further comprising a voltage generator for applied a voltage across at least one of said second hologram and said third holographic recording medium; characterised in that said voltage varies the refractive index modulation of at least one of said second hologram and said third during steps g) to i).

15. The method of claim 1 wherein said second holographic recording medium is one of a photo thermal refractive or holographic photopolymer, a forward mode HPDLC mixture or a reverse mode HPDLC mixture.

16. The method of claim 1 wherein said third holographic recording medium is one of a photo thermal refractive or photopolymer, a forward mode HPDLC mixture or a reverse mode HPDLC mixture.

17. The method of claim 1 wherein the diffracting thickness of said first hologram is less than or equal to 2 micron.

18. A method of mastering and replicating holograms, the method comprising:
a) providing a laser apparatus for forming a first recording beam in a first direction and a second recording beams in a second direction; N substrates each containing a first HPDLC mixture; a holography photopolymer; a copy holographic substrate containing a second HPDLC mixture; a HWP; and a linear polarizer;
b) said first and second beams interfering within each said first HPDLC mixture to form a first hologram in each said substrate;
c) stacking in sequence the linear polarizer, HWP and first holograms 1-N onto said second holographic photopolymer;
d) illuminating external surface of said hologram N with light of a first polarization in said first direction;
e) said first holograms 1-N diffracting said light into zero order light in said first direction and diffracted light in said second direction;
f) said HWF rotating the incident light polarization through ninety degrees into a second polarization;
g) said polarizer removing residual first polarization light;
h) said first direction light and said second direction light interfering in said holographic photopolymer to form a second hologram;
i) placing said second hologram in contact with said copy holographic substrate;
j) illuminating external surface of said second hologram with light of said second polarization in said first direction;
k) said second hologram diffracting said light into zero order light in said first direction and diffracted light in said second direction;
l) said diffracted and first order interfering in said copy holographic substrate to form a third hologram.

19. The method of claim 18 wherein said steps d) to l) are repeated for a multiplicity of values of said first and second directions, wherein said first and second directions are limited by the diffraction efficiency angular bandwidth of said first hologram.

20. The method of claim wherein said first polarization is P and said second polarization is S.
